(19) United States
(12) Patent Application Publication
(10) Pub. No.: US 2009/0100639 A1
(43) Pub. Date: Apr. 23, 2009

(54) Hinge structure applied to a portable electronic device

(76) Inventors: Yi-Wei Tao, Hsichih (TW); Ming-Jen Huang, Hsichih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,279

(22) Filed: Mar. 4, 2008

(30) Foreign Application Priority Data
Oct. 17, 2007 (TW) 96217350

(51) Int. Cl. E05D 11/00

(52) U.S. Cl. 16/250

(57) ABSTRACT

A hinge structure applied to a portable electronic device that has a first cover structure and a second cover structure, includes a receiving unit and a hinge unit. The receiving unit is formed on the first cover structure, and the receiving unit has at least one receiving space and two guiding tracks disposed on two opposite inner sides of the at least one receiving space. The hinge unit is disposed on the second cover structure. The hinge unit has at least one hinge body received in the at least one receiving space and two pivots respectively disposed on two opposite lateral sides of the at least one hinge body and slidably received in the two guiding tracks. Therefore, the first cover structure and the second cover structure pivot to each other and slid with respect to each other by matching the two pivots and the two guiding tracks.

### BACKGROUND OF THE INVENTION

1. Field of the Invention

The present invention relates to a hinge structure, and particularly relates to a hinge structure applied to a portable electronic device.

2. Description of the Related Art

In general, portable computers of the present art do not have a lock structure in order to lock a screen of the portable computer and restrict the position of the screen. Hence, the position of the screen is not restricted, and thus a user cannot use in a stable manner a touch pad function of the screen of the portable computer of the present art when the user is standing or walking. In other words, when the user is using the touch pad function of the screen (this means the user applies a pressing force to specific areas of the screen in order to activate certain functions) during standing or walking, the screen is moving due to the force applied by the user.

### SUMMARY OF THE INVENTION

One particular aspect of the present invention is to provide a hinge structure applied to a portable electronic device. One embodiment of the hinge structure has four pivots and guiding tracks matched with each other, so that a first cover structure with an image-display module can be pushed toward a second cover structure with a key module (it means that the first cover structure is pushed toward a user) to generate an overlapping area between the first cover structure and the second cover structure for restricting the position of the first cover structure relative to the second cover structure (it means that the present invention can prevent the first cover structure from being rotated and moved relative to the second cover structure). Therefore, when the position of the first cover structure relative to the second cover structure is restricted, the first cover structure with an image-display module is in a stable state (it means that the first cover structure cannot be shaken relative to the second cover structure). Hence, the user can use the portable electronic device in a stable manner, when the user is standing or walking.

Furthermore, another embodiment of the hinge structure has four pivots and guiding tracks matched with each other, so that a second cover structure with an image-display module can be pushed toward a first cover structure with a key module (it means that the second cover structure is pushed toward a user) to generate an overlapping area between the first cover structure and the second cover structure for restricting the position of the second cover structure relative to the first cover structure (it means that the present invention can prevent the second cover structure from being rotated and moved relative to the first cover structure). Therefore, when the position of the second cover structure relative to the first cover structure is restricted, the second cover structure with the image-display module is in a stable state (it means that the second cover structure cannot be shaken relative to the first cover structure). Hence, the user can use the portable electronic device in a stable manner, when the user is standing or walking.

In order to achieve the above-mentioned aspects, the present invention provides a hinge structure applied to a portable electronic device that has a first cover structure and a second cover structure. The hinge structure includes a receiving unit and a hinge unit. The receiving unit is formed on the first cover structure, and the receiving unit has at least one receiving space and two guiding tracks disposed on two opposite inner sides of the at least one receiving space. The hinge unit is disposed on the second cover structure. The hinge unit has at least one hinge body received in the at least one receiving space and two pivots respectively disposed on two opposite lateral sides of the at least one hinge body and slidably received in the two guiding tracks. Therefore, the first cover structure and the second cover structure pivot to each other and slid with respect to each other by matching the two pivots and the two guiding tracks.

In other words, the present invention provides a hinge structure applied to a portable electronic device that has a first cover structure and a second cover structure. The hinge structure is disposed between the first cover structure and the second cover structure, and the hinge structure has at least one hinge body in order to make the first cover structure and the second cover structure pivoted to each other and slid with respect to each other. Moreover, the first cover structure has an image-display module, and the second cover structure has a key module. Alternatively, the first cover structure has a key module, and the second cover structure has an image-display module.

Because the hinge structure is disposed between the first cover structure and the second cover structure, the first cover structure and the second cover structure pivot to each other and slid with respect to each other. For example, the hinge structure disposed between the first cover structure with the image-display module and the second cover structure with the key module generates some advantages, as follows:

1. Because the first cover structure and the second cover structure are slid with respect to each other, the first cover structure and the second cover structure are restricted with each other.

2. Because the overlapping area between the first cover structure and the second cover structure, the position of the first cover structure relative to the second cover structure is restricted.

3. Because the position of the first cover structure relative to the second cover structure is restricted, the first cover structure with the image-display module is in a stable state (it means that the first cover structure cannot be shaken relative to the second cover structure). Hence, the user can use the portable electronic device in a stable manner, when the user is standing or walking.

4. Because the image-display module of the first cover structure has a touch pad function, the user still can use the touch pad function of the image-display module in a stable manner (the user presses a force F onto the image-display module D) during standing or walking due to the position restriction relationship between the first cover structure and the second cover structure.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, exploded view of a hinge structure applied to a portable electronic device according to the first embodiment of the present invention;

FIG. 1A is a perspective, assembled view of a first cover structure covered on a second cover structure according to the first embodiment of the present invention;

FIG. 1B is a perspective, assembled view of a first cover structure opened by a predetermined angle relative to the second cover structure according to the first embodiment of the present invention;

FIG. 1C1 is a perspective, assembled view of a first cover structure opened by 180 degrees relative to the second cover structure according to the first embodiment of the present invention;

FIG. 1C2 is a lateral, schematic view of a first cover structure opened by 180 degrees relative to the second cover structure according to the first embodiment of the present invention;

FIG. 1D1 is a perspective, assembled view of a first cover structure pushed toward the second cover structure according to the first embodiment of the present invention;

FIG. 1D2 is a lateral, schematic view of a first cover structure pushed toward the second cover structure according to the first embodiment of the present invention;

FIG. 2 is a perspective, exploded view of a hinge structure applied to a portable electronic device according to the second embodiment of the present invention;

FIG. 2A is a perspective, assembled view of a second cover structure covered on a first cover structure according to the second embodiment of the present invention;

FIG. 2B is a perspective, assembled view of a second cover structure opened by a predetermined angle relative to the first cover structure according to the second embodiment of the present invention;

FIG. 2C1 is a perspective, assembled view of a second cover structure opened by 180 degrees relative to the first cover structure according to the second embodiment of the present invention;

FIG. 2C2 is a lateral, schematic view of a second cover structure opened by 180 degrees relative to the first cover structure according to the second embodiment of the present invention;

FIG. 2D1 is a perspective, assembled view of a second cover structure pushed toward the first cover structure according to the second embodiment of the present invention; and

FIG. 2D2 is a lateral, schematic view of a second cover structure pushed toward the first cover structure according to the second embodiment of the present invention.

### DETAILED DESCRIPTION OF THE PREFERRED EMBODIMENTS

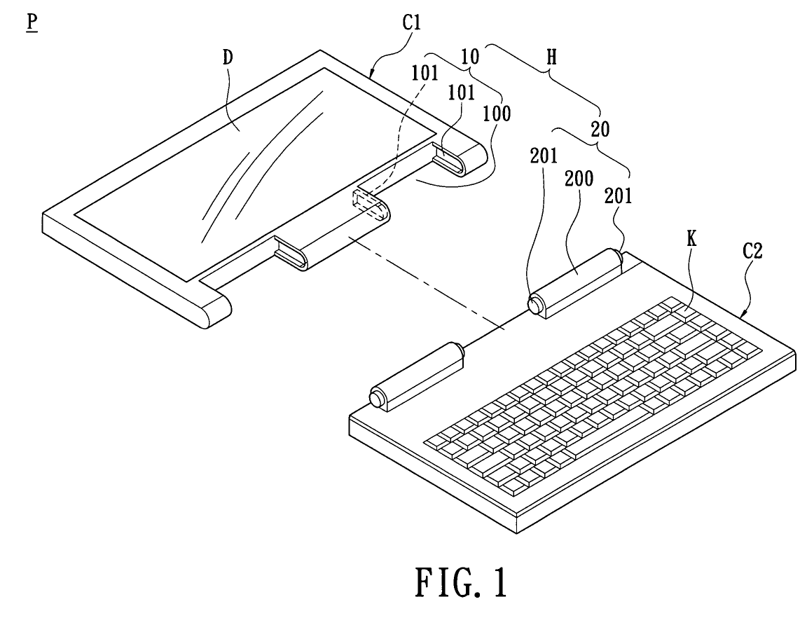

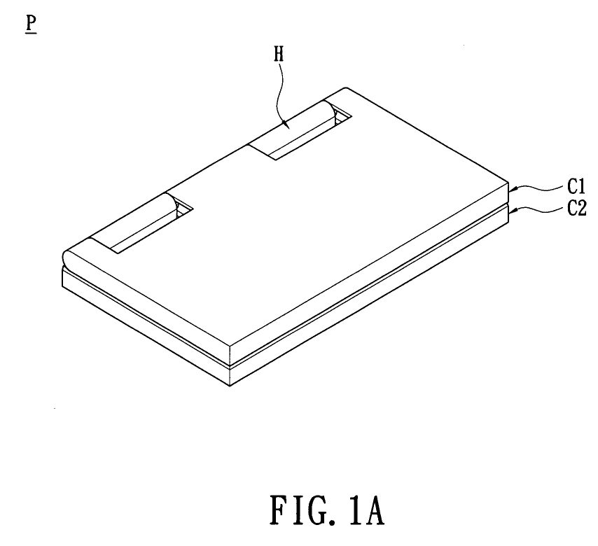

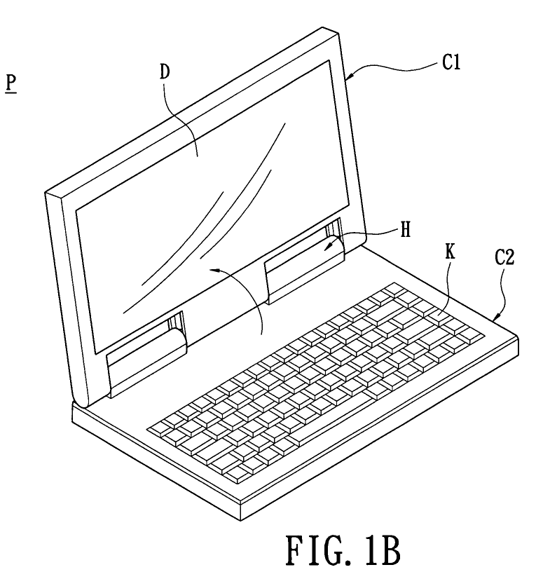

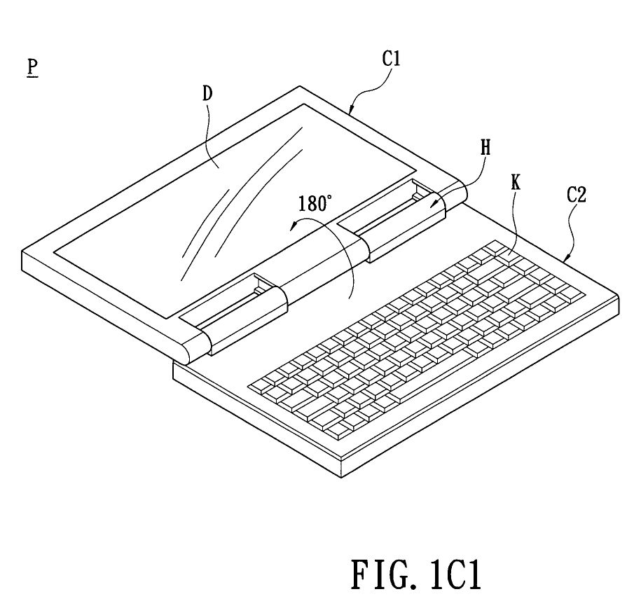

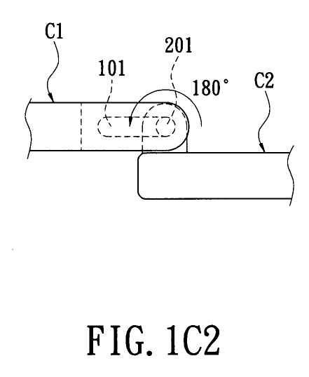

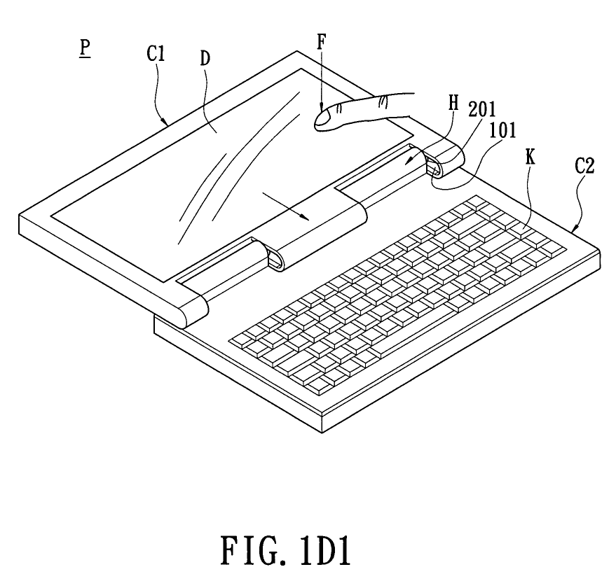

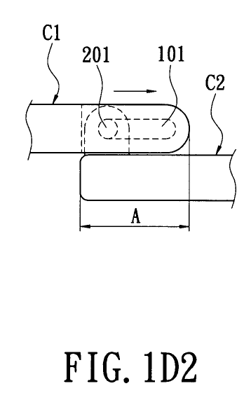

Referring to FIGS. 1 and 1A to 1D2, FIG. 1 shows a perspective, exploded view of a hinge structure applied to a portable electronic device according to the first embodiment of the present invention, FIG. 1A shows a perspective, assembled view of a first cover structure covered on a second cover structure according to the first embodiment of the present invention, FIG. 1B shows a perspective, assembled view of a first cover structure opened by a predetermined angle relative to the second cover structure according to the first embodiment of the present invention, FIG. 1C1 shows a perspective, assembled view of a first cover structure opened by 180 degrees relative to the second cover structure according to the first embodiment of the present invention, FIG. 1C2 shows a lateral, schematic view of a first cover structure opened by 180 degrees relative to the second cover structure according to the first embodiment of the present invention, FIG. 1D1 shows a perspective, assembled view of a first cover structure pushed toward the second cover structure according to the first embodiment of the present invention, and FIG. 1D2 shows a lateral, schematic view of a first cover structure pushed toward the second cover structure according to the first embodiment of the present invention.

Referring to FIG. 1, the first embodiment of the present invention provides a hinge structure H applied to a portable electronic device P that has a first cover structure C1 and a second cover structure C2. The first cover structure C1 has an image-display module D, and the second cover structure C2 has a key module K. The hinge structure H is disposed between the first cover structure C1 and the second cover structure C2.

The hinge structure H includes a receiving unit 10 and a hinge unit 20. The receiving unit 10 is disposed on one lateral side of the first cover structure C1, and the hinge unit 20 corresponds to the receiving unit 10 and is disposed on one lateral side of the second cover structure C2. In addition, the receiving unit 10 has two receiving spaces 100 and four guiding tracks 101. Each two guiding tracks 101 are respectively disposed on two opposite inner sides of the corresponding receiving space 100. The hinge unit 20 has two hinge bodies 200 respectively received in the two receiving spaces 100 and four pivots 201. Each two pivots 201 are respectively disposed on two opposite lateral sides of the corresponding hinge body 200. In the first embodiment, each guiding track 101 can be an elongated groove with a long and straight shape in longitudinal direction, and each pivot 201 can be a column pivot. The elongated groove has a longitudinal length larger than a diameter of the column pivot. Therefore, each two pivots 201 can be slidably received in each two corresponding guiding tracks 101.

Furthermore, referring to FIGS. 1A to 1C2, the first cover structure C1 and the second cover structure C2 pivot to each other by matching the four pivots 201 and the four guiding tracks 101. In other words, the four pivots 201 and the four guiding tracks 101 are matched with each other, so that the first embodiment of the present invention can perform some actions such as the first cover structure C1 is covered on the second cover structure C2 (as shown in FIG. 1A), the first cover structure C1 is opened by a predetermined angle relative to the second cover structure C2 (as shown in FIG. 1B), and the first cover structure C1 is opened by 180 degrees relative to the second cover structure C2 (as shown in FIGS. 1C1 and 1C2) etc. In addition, the action of opening the first cover structure C1 by 180 degrees relative to the second cover structure C2 does not used to limit the present invention. According to designer's requirement, the first cover structure C1 can be designed into be opened by greater or smaller than 180 degrees relative to the second cover structure C2.

Moreover, referring to FIGS. 1D1 and 1D2, the first cover structure C1 and the second cover structure C2 are slid with respect to each other by matching the four pivots 201 and the four guiding tracks 101. In other words, the four pivots 201 and the four guiding tracks 101 are matched with each other, so that the first cover structure C1 can be pushed toward the second cover structure C2 (it means that the first cover structure C1 is pushed toward a user) to generate an overlapping area between the first cover structure C1 and the second cover structure C2 for restricting the position of the first cover structure C1 relative to the second cover structure C2 (it means that the present invention can prevent the first cover structure C1 from being rotated and moved relative to the second cover structure C2). Therefore, when the position of the first cover structure C1 relative to the second cover structure C2 is restricted, the first cover structure C1 with the image-display module D is in a stable state (it means that the first cover structure C1 cannot be shaken relative to the second cover structure C2). Hence, the user can use the portable electronic device P in a stable manner, when the user is standing or walking.

In addition, when the image-display module D of the first cover structure C1 has a touch pad function, the user still can use the touch pad function of the image-display module D in a stable manner during standing or walking due to the position restriction relationship between the first cover structure C1 and the second cover structure C2. In other words, when the user presses a force F onto the image-display module D to use the touch pad function (as shown an arrow in FIG. 1D1), the first cover structure C1 cannot be shaken.

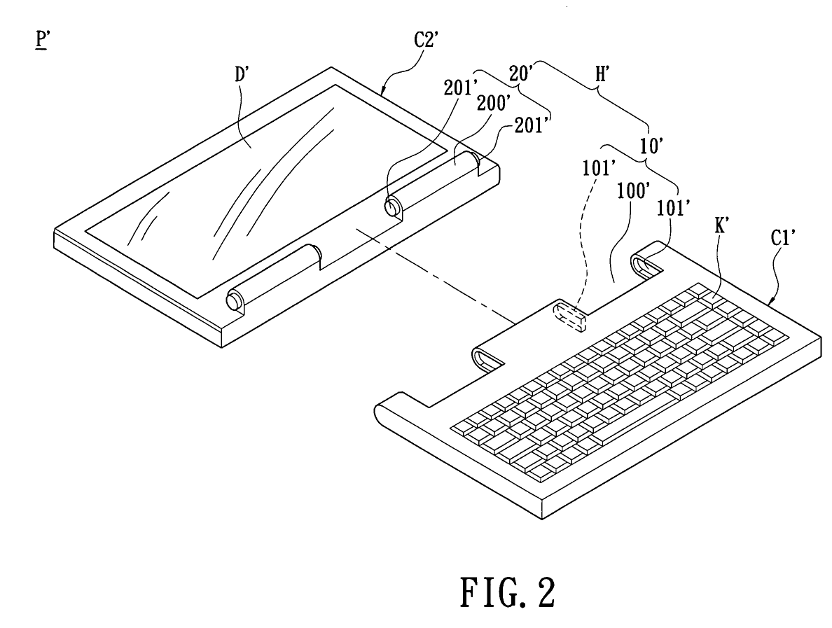

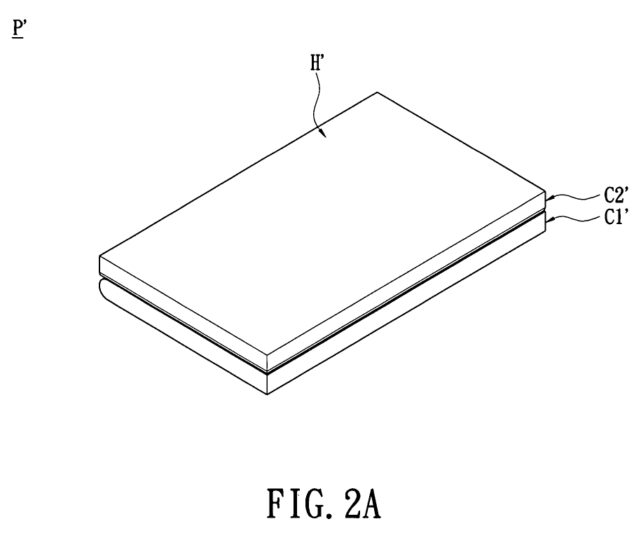

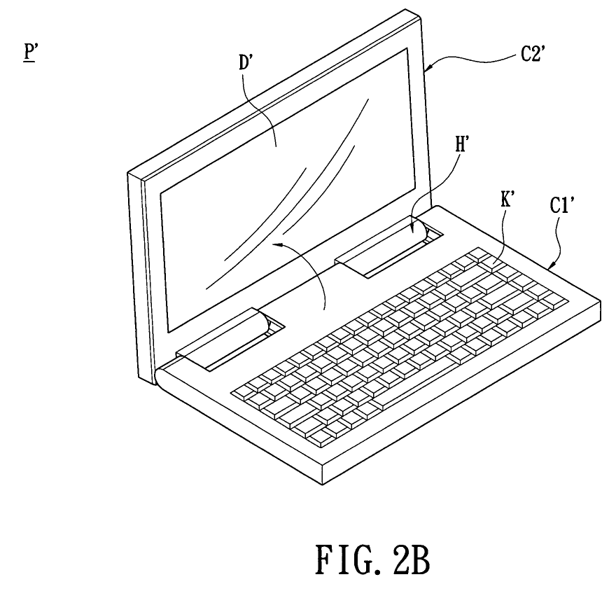

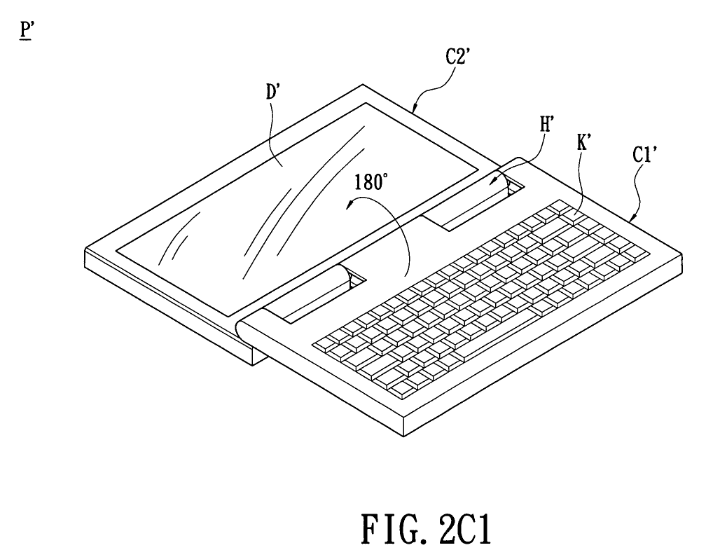

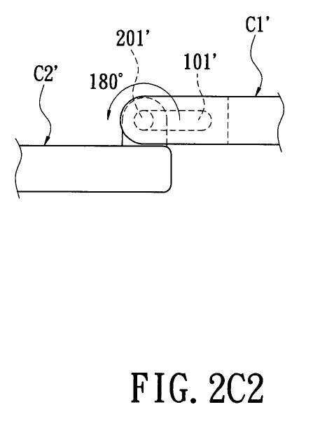

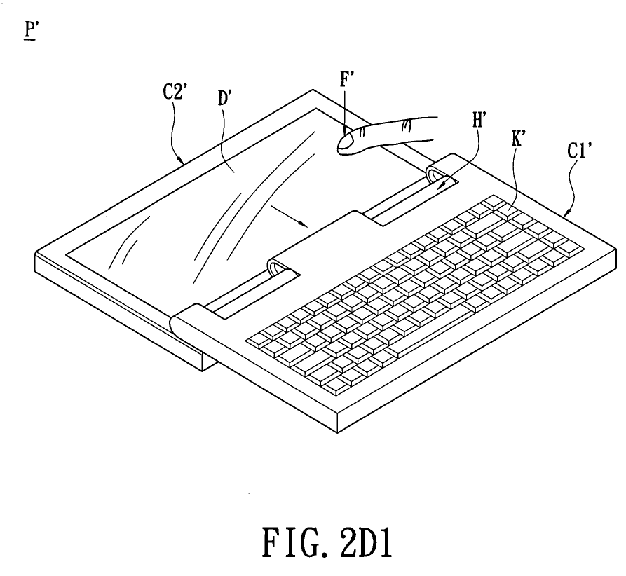

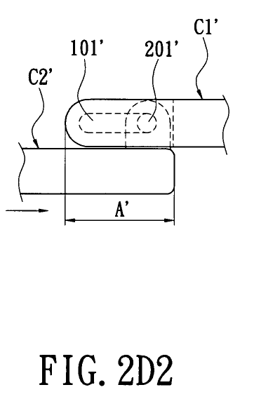

Referring to FIGS. 2 and 2A to 2D2, FIG. 2 shows a perspective, exploded view of a hinge structure applied to a portable electronic device according to the second embodiment of the present invention, FIG. 2A shows a perspective, assembled view of a second cover structure covered on a first cover structure according to the second embodiment of the present invention, FIG. 2B shows a perspective, assembled view of a second cover structure opened by a predetermined angle relative to the first cover structure according to the second embodiment of the present invention, FIG. 2C1 shows a perspective, assembled view of a second cover structure opened by 180 degrees relative to the first cover structure according to the second embodiment of the present invention, FIG. 2C2 shows a lateral, schematic view of a second cover structure opened by 180 degrees relative to the first cover structure according to the second embodiment of the present invention, FIG. 2D1 shows a perspective, assembled view of a second cover structure pushed toward the first cover structure according to the second embodiment of the present invention, and FIG. 2D2 shows a lateral, schematic view of a second cover structure pushed toward the first cover structure according to the second embodiment of the present invention.

Referring to FIG. 2, the second embodiment of the present invention provides a hinge structure H′ applied to a portable electronic device P′ that has a first cover structure C1′ and a second cover structure C2′. The first cover structure C1′ has a key module K′, and the second cover structure C2′ has an image-display module D′. The hinge structure H′ is disposed between the first cover structure C1′ and the second cover structure C2′.

The hinge structure H′ includes a receiving unit 10′ and a hinge unit 20′. The receiving unit 10′ is disposed on one lateral side of the first cover structure C1′, and the hinge unit 20′ corresponds to the receiving unit 10′ and is disposed on one lateral side of the second cover structure C2′. In addition, the receiving unit 10′ has two receiving spaces 100′ and four guiding tracks 101′. Each two guiding tracks 101′ are respectively disposed on two opposite inner sides of the corresponding receiving space 100′. The hinge unit 20′ has two hinge bodies 200′ respectively received in the two receiving spaces 100′ and four pivots 201′. Each two pivots 201′ are respectively disposed on two opposite lateral sides of the corresponding hinge body 200′. In the second embodiment, each guiding track 101′ can be an elongated groove with a long and straight shape in longitudinal direction, and each pivot 201′ can be a column pivot. The elongated groove has a longitudinal length larger than a diameter of the column pivot. Therefore, each two pivots 201′ can be slidably received in each two corresponding guiding tracks 101′.

Hence, referring to FIGS. 1 and 2, the difference between the second embodiment and the first embodiment is that: in the second embodiment, the receiving unit 10′ is disposed on one lateral side of the first cover structure C1′, and the hinge unit 20′ corresponds to the receiving unit 10′ and is disposed on one lateral side of the second cover structure C2′.

Therefore, according to the action principle of the first embodiment (as shown in FIGS. 1A to 1D2), the action principle of the second embodiment is shown as follows:

Furthermore, referring to FIGS. 2A to 2C2, the first cover structure C1′ and the second cover structure C2′ pivot to each other by matching the four pivots 201′ and the four guiding tracks 101′. In other words, the four pivots 201′ and the four guiding tracks 101′ are matched with each other, so that the second embodiment of the present invention can perform some actions such as the second cover structure C2′ is covered on the first cover structure C1′ (as shown in FIG. 2A), the second cover structure C2′ is opened by a predetermined angle relative to the first cover structure C1′ (as shown in FIG. 2B), and the second cover structure C2′ is opened by 180 degrees relative to the first cover structure C1′ (as shown in FIGS. 2C1 and 2C2) etc. In addition, the action of opening the second cover structure C2′ by 180 degrees relative to the first cover structure C1′ does not used to limit the present invention. According to designer's requirement, the second cover structure C2′ can be designed into be opened by greater or smaller than 180 degrees relative to the first cover structure C1′.

Moreover, referring to FIGS. 2D1 and 2D2, the first cover structure C1′ and the second cover structure C2′ are slid with respect to each other by matching the four pivots 201′ and the four guiding tracks 101′. In other words, the four pivots 201′ and the four guiding tracks 101′ are matched with each other, so that the second cover structure C2′ can be pushed toward the first cover structure C1′ (it means that the second cover structure C2′ is pushed toward a user) to generate an overlapping area between the first cover structure C1′ and the second cover structure C2′ for restricting the position of the second cover structure C2′ relative to the first cover structure C1′ (it means that the present invention can prevent the second cover structure C2′ from being rotated and moved relative to the first cover structure C1′). Therefore, when the position of the second cover structure C2′ relative to the first cover structure C1′ is restricted, the second cover structure C2′ with the image-display module D′ is in a stable state (it means that the second cover structure C2′ cannot be shaken relative to the first cover structure C1′). Hence, the user can use the portable electronic device P′ in a stable manner, when the user is standing or walking.

In addition, when the image-display module D′ of the second cover structure C2′ has a touch pad function, the user still can use the touch pad function of the image-display module D′ in a stable manner during standing or walking due to the position restriction relationship between the first cover structure C1′ and the second cover structure C2′. In other words, when the user presses a force F′ onto the image-display module D′ to use the touch pad function (as shown an arrow in FIG. 2D1), the second cover structure C2′ cannot be shaken.

In conclusion, because the hinge structure (H or H′) is disposed between the first cover structure (C1 or C1′) and the second cover structure (C2 or C2′), the first cover structure (C1 or C1′) and the second cover structure (C2 or C2′) pivot to each other and slid with respect to each other. For example, the hinge structure of the first embodiment has some advantages, as follows:

1. Because the first cover structure C1 and the second cover structure C2 are slid with respect to each other, the first cover structure C1 and the second cover structure C2 are restricted with each other.

2. Because the overlapping area between the first cover structure C1 and the second cover structure C2, the position of the first cover structure C1 relative to the second cover structure C2 is restricted.

3. Because the position of the first cover structure C1 relative to the second cover structure C2 is restricted, the first cover structure C1 with the image-display module D is in a stable state (it means that the first cover structure C1 cannot be shaken relative to the second cover structure C2). Hence, the user can use the portable electronic device P in a stable manner, when the user is standing or walking.

4. Because the image-display module D of the first cover structure C1 has a touch pad function, the user still can use the touch pad function of the image-display module D in a stable manner (the user presses a force F onto the image-display module D) during standing or walking due to the position restriction relationship between the first cover structure C1 and the second cover structure C2.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hinge structure applied to a portable electronic device that has a first cover structure and a second cover structure, the hinge structure comprising:
a receiving unit formed on the first cover structure, wherein the receiving unit has at least one receiving space and two guiding tracks disposed on two opposite inner sides of the at least one receiving space; and
a hinge unit disposed on the second cover structure, wherein the hinge unit has at least one hinge body received in the at least one receiving space and two pivots respectively disposed on two opposite lateral sides of the at least one hinge body and slidably received in the two guiding tracks;
whereby, the first cover structure and the second cover structure pivot to each other and slid with respect to each other by matching the two pivots and the two guiding tracks.

2. The hinge structure as claimed in claim 1, wherein the receiving unit is disposed on one lateral side of the first cover structure, and the hinge unit corresponds to the receiving unit and is disposed on one lateral side of the second cover structure.

3. The hinge structure as claimed in claim 1, wherein each guiding track is an elongated groove with a long and straight shape in longitudinal direction, each pivot is a column pivot, and the elongated groove has a longitudinal length larger than a diameter of the column pivot.

4. The hinge structure as claimed in claim 1, wherein the first cover structure has an image-display module, and the second cover structure has a key module.

5. The hinge structure as claimed in claim 1, wherein the first cover structure has a key module, and the second cover structure has an image-display module.

6. A hinge structure applied to a portable electronic device that has a first cover structure and a second cover structure, the hinge structure disposed between the first cover structure and the second cover structure, and the hinge structure has at least one hinge body in order to make the first cover structure and the second cover structure pivoted to each other and slid with respect to each other.

7. The hinge structure as claimed in claim 6, further comprising: a receiving unit formed on the first cover structure, wherein the receiving unit has at least one receiving space and two guiding tracks disposed on two opposite inner sides of the at least one receiving space, the at least one hinge body is received in the at least one receiving space, and each guiding track is an elongated groove with a long and straight shape in longitudinal direction.

8. The hinge structure as claimed in claim 7, further comprising: two pivots respectively disposed on two opposite lateral sides of the at least one hinge body and slidably received in the two guiding tracks, wherein each pivot is a column pivot, and the elongated groove has a longitudinal length larger than a diameter of the column pivot.

9. The hinge structure as claimed in claim 6, wherein the first cover structure has an image-display module, and the second cover structure has a key module.

10. The hinge structure as claimed in claim 6, wherein the first cover structure has a key module, and the second cover structure has an image-display module.
